(19) United States
(12) Patent Application Publication
(10) Pub. No.: US 2025/0353770 A1
(43) Pub. Date: Nov. 20, 2025

(54) SYSTEMS AND METHODS FOR WASTEWATER RECYCLING AND RECOVERY

(71) Applicant: GreenSource Fabrication LLC, Charlestown, NH (US)

(72) Inventors: Mark Martin GIRARD, Windsor, VT (US); Derek John LOVEJOY, Milford, NH (US)

(73) Assignee: GreenSource Fabrication LLC, Charlestown, NH (US)

(21) Appl. No.: 19/207,776

(22) Filed: May 14, 2025

Related U.S. Application Data
(60) Provisional application No. 63/647,429, filed on May 14, 2024.

(51) Int. Cl. C02F 9/00; C02F 1/00; C02F 1/32; C02F 1/42; C02F 1/44; C02F 1/469; C02F 1/66; C02F 1/78; C02F 101/20

(52) U.S. Cl. CPC C02F 9/00; C02F 1/001; C02F 1/32; C02F 1/42; C02F 1/441; C02F 1/4693; C02F 1/4695; C02F 1/66; C02F 1/78; C02F 2101/20; C02F 2209/06

(57) ABSTRACT

A wastewater system with high recyclability may include one or more mechanical or membrane filtration technologies. Process waste streams may be processed through a variety of processing units to remove contaminants without or with limited additional chemical additives, thereby forming a near-zero or zero liquid discharge wastewater system.

### CROSS-REFERENCE TO RELATED APPLICATIONS

This non-provisional application claims the benefit of priority to U.S. Provisional Application Ser. No. 63/647,429 filed May 14, 2024 which is incorporated in its entirety herein for all purposes.

### BACKGROUND

### 1. Field of the Disclosure

The present disclosure relates to recovery operations. Specifically, the present disclosure relates to systems and methods for wastewater and material recovery in one or more fabrication processes. More specifically, the present disclosure relates to zero or near-zero liquid discharge waste and water recovery system with high recyclability.

### 2. Description of Related Art

Various manufacturing processes may use a variety of materials and chemicals that generate waste or wastewater. The waste and/or wastewater may contain complex chemical compounds which are treated to neutralize or minimize various impacts of these chemicals on the environment, for example when the waste and/or wastewater is disposed. A variety of techniques may be used to treat waste and wastewater, such as bacteria for the biological decomposition waste, reverse osmosis and ion exchange technologies, and dilute rinse water recycling, among various other methods. When using chemical for ion exchange or the like, chemical solutions may be batch treated along with other concentrated water streams to remove regulated metals. In addition, further processing may be implemented to remove regulated organics. While these approaches can obtain high recycling levels, significant waste may still be generated and/or additional chemical injection or use may be used, thereby reducing the overall effectiveness of the system.

### SUMMARY

Applicant recognized the problems noted above herein and conceived and developed embodiments of systems and methods, according to the present disclosure, for wastewater treatment systems.

In an embodiment, a wastewater treatment method includes receiving one or more input waste streams to create a wastewater stream. The method includes processing at least a portion of the wastewater stream to breakdown and remove one or more contaminants using at least one of an ozone treatment process, a light filtering process, electrofiltration process, electro chemical oxidation process, or a physical filtering process to create a processed wastewater stream. The method includes processing at least a portion of the processed wastewater stream to remove one or more contaminants to create a high conductivity wastewater stream. The method includes processing at least a portion of the high conductivity wastewater stream using one or more first membrane processing systems to create a deionized wastewater stream. The first membrane processing system may include, for example, a continuous electrodeionization (CEDI) system, an electrodeionization (EDI) system, or an electrodialysis system. The first membrane could also be reverse osmosis (RO) membrane system, or any other membrane system that deionizes the waste water or produces a deionized stream. Alternatively, instead of using a first membrane, the system could include an ion exchange. The method includes processing at least a portion of the deionized wastewater stream using one or more second membrane processing systems to create a polished wastewater stream. The method includes processing at least a portion of the polished wastewater stream using at least one of a light filtering process or a physical filtering process to create a recycled wastewater stream. The method includes providing the recycled wastewater stream for use in one or more manufacturing processes used to create at least a portion of the one or more input waste streams.

In an embodiment, a wastewater treatment method includes receiving one or more input waste streams to create a combined waste stream. The method includes processing at least a portion of the combined waste stream to remove one or more metal alloys and create a reduced metal stream. The method includes processing at least a portion of the reduced metal stream to modify the pH of the reduced metal stream to create a neutral metal stream. The method includes processing at least a portion of the neutral metal stream to remove residue to create a filter cake and a filtered neutral stream. For example, the neutral metal stream may be fed into a pH tank, along with some dosing from the reduced metal stream as a neutralizer. Additional neutral to high pH waste, such as organic waste, may be fed into the pH tank as well. The output from the pH tank feeds a drum filter, which filters the output into a filter cake and produces a filtered neutral stream. The method includes processing at least a portion of the filtered neutral stream using one or more membrane processing systems to create a brine stream. The method includes processing at least a portion of the brine stream to create an input fluid waste stream and a solid waste. The brine stream can be processed using, for example, thermal evaporation/drying with or without a vacuum, centrifugal separation, dewatering units, sludge settlement and crystallization, or other techniques to produce an outlet fluid and/or outlet solid waste.

In another embodiment, a waste treatment method includes receiving one or more input waste streams to create a wastewater stream. The method also includes processing at least a portion of the wastewater stream to breakdown and remove one or more contaminants using at least one of an ozone treatment process, a light filtering process, electrofiltration process, electro chemical oxidation process, or a physical filtering process to create a processed wastewater stream. The method includes processing at least a portion of the processed wastewater stream to remove one or more contaminants to create a high conductivity wastewater stream. The method includes processing at least a portion of the high conductivity wastewater stream using one or more first membrane processing systems to create a deionized wastewater stream. The method includes processing at least a portion of the deionized wastewater stream using one or more second membrane processing systems to create a polished wastewater stream. The method includes processing at least a portion of the polished wastewater stream using at least one of a light filtering process or a physical filtering process to create a recycled wastewater stream. The method includes providing the recycled wastewater stream for use in one or more manufacturing processes used to create at least a portion of the one or more input waste streams. The method includes receiving one or more input metal waste streams to create a combined waste stream. The method includes processing at least a portion of the combined waste stream to remove one or more metal alloys and create a reduced metal stream. The method includes processing at least a portion of the reduced metal stream to modify the pH of the reduced metal stream to create a neutral metal stream. The method includes processing at least a portion of the neutral metal stream to remove residue to create a filter cake and a filtered neutral stream. The method includes processing at least a portion of the filtered neutral stream using one or more membrane processing systems to create a brine stream. The method includes processing at least a portion of the brine stream to create an input fluid waste stream and a solid waste.

### BRIEF DESCRIPTION OF DRAWINGS

The foregoing aspects, features, and advantages of the present disclosure will be further appreciated when considered with reference to the following description of embodiments and accompanying drawings. In describing the embodiments of the disclosure illustrated in the appended drawings, specific terminology will be used for the sake of clarity. However, the disclosure is not intended to be limited to the specific terms used, and it is to be understood that each specific term includes equivalents that operate in a similar manner to accomplish a similar purpose.

FIG. 1 is a schematic process flow diagram an embodiment of a wastewater treatment process, in accordance with embodiments of the present disclosure;

FIG. 2 is a schematic process flow diagram of an embodiment of a wastewater treatment process, in accordance with embodiments of the present disclosure;

FIGS. 3A and 3B are schematic process flow diagrams of an embodiment of a wastewater treatment process, in accordance with embodiments of the present disclosure;

FIG. 4 is a schematic process flow diagram an embodiment of a wastewater treatment process, in accordance with embodiments of the present disclosure;

FIG. 5 is a schematic process flow diagram an embodiment of a wastewater treatment process, in accordance with embodiments of the present disclosure; and

FIG. 6 is a schematic diagram of a control scheme for a wastewater treatment process, in accordance with embodiments of the present disclosure.

### DETAILED DESCRIPTION

The foregoing aspects, features, and advantages of the present disclosure will be further appreciated when considered with reference to the following description of embodiments and accompanying drawings. In describing the embodiments of the disclosure illustrated in the appended drawings, specific terminology will be used for the sake of clarity. However, the disclosure is not intended to be limited to the specific terms used, and it is to be understood that each specific term includes equivalents that operate in a similar manner to accomplish a similar purpose.

When introducing elements of various embodiments of the present disclosure, the articles “a”, “an”, “the”, and “said” are intended to mean that there are one or more of the elements. The terms “comprising”, “including”, and “having” are intended to be inclusive and mean that there may be additional elements other than the listed elements. Any examples of operating parameters and/or environmental conditions are not exclusive of other parameters/conditions of the disclosed embodiments. Additionally, it should be understood that references to “one embodiment”, “an embodiment”, “certain embodiments”, or “other embodiments” of the present disclosure are not intended to be interpreted as excluding the existence of additional embodiments that also incorporate the recited features. Furthermore, reference to terms such as “above”, “below”, “upper”, “lower”, “side”, “front”, “back”, or other terms regarding orientation or direction are made with reference to the illustrated embodiments and are not intended to be limiting or exclude other orientations or directions. It should be further appreciated that terms such as approximately or substantially may indicate +/−10 percent.

Embodiments of the present disclosure are directed toward a zero (e.g., near-zero) liquid discharge wastewater system with high recyclability. One or more embodiments may utilize little to no liquid chemical consumption by utilizing mechanical and membrane-based filtration technologies. Furthermore, at least one embodiment may use waste in place of using chemicals for neutralization. At least one embodiment may further incorporate one or more diversion valves and along with one or more control schemes using operational set points to enable the system to be a managed, tunable system with respect to one or more desired operating parameters. In at least one embodiment, systems and methods may be deployed to reduce particular water contaminants during recovery and reuse cycles. In at least one embodiment, systems and methods may be deployed for targeted recycling and/or recovery of certain materials, such as metal alloys.

In at least one embodiment, systems and methods may include one or more trains or operating processes, where a first train may be used for wastewater treatment and/or recovery of processing water/chemicals and a second may be used for chemical treatment and/or recovery of materials. It should be appreciated that the reference to multiple trains is by way of non-limiting example for clarity with the discussion and is not intended to imply that two separate trains are used in all embodiments and/or that additional trains may not be used and/or that features may not be combined within single trains. Spent process water (SPW) may be collected from one or more processes, which may include recovery processes, from a production floor. As one example, product water may be considered SPW, rejection water from one or more recovery systems may be considered SPW, permeate water may be considered SPW, distillation products may be considered SPW, and/or various other streams may be considered SPW. The SPW may be directed toward one or more tanks or storage containers. As discussed herein the one or more tanks may be used as a buffer for various processes, but it should be appreciated that continuous processing, batch processing, or process controls may be used to reduce or eliminate use of various tanks or storage containers associated with the system. Furthermore, at least one embodiment may deploy one or more sensors or analyzers to selectively store SPW into a desired tank.

As one example, the SPW may be passed through one or more processing systems, which may include by way of non-limiting example, one or more ozone injection processes, one or more light treatment processes, electrofiltration processes, electro chemical oxidation processes, and/or other filtering processes. Examples may include Ozone injection or an Advanced Oxidation Process (AOP), UV/visible light filtering, bag filters, and/or the like. In at least one embodiment, the one or more processes may be considered in-line processes. For example, an inline AOP treatment may be used to destruct and target against organic and biofoul contaminants, enabling filtering of the targeted organics. In at least one embodiment, the ozone injection may be an inline system, such as a venturi injector that uses pressure differential to inject the ozone into the SPW to be treated. In operation, the ozone breaks down and oxidizes organics, and forms particulates to be captured by filtration. Additionally, systems and methods may include UV/visible light filtering, for example, to breakdown residual Ozone that was not consumed in the previous processing steps. Filtering may include one or more bag filters to collect the particulates from the Ozonation or AOP process. In at least one embodiment, one or more sensors, such as an inline O3 sensor, monitors and confirms process performance for UV destruction and/or the like. It should be appreciated that one or more additional or alternative systems may be used, such as the use of chemical additives for oxidation. Furthermore, one or more bag filters may be used, such as train with gradually reducing filter sizes, and/or various other methods to remove particulates, such as hydrocyclones, various membranes, and/or the like.

In at least one embodiment, the process may continue along the first train by directing the output of the processing and filtering steps to a collection device that may be used for additional processing, such as a Granular Activated Carbon (GAC) system. GAC may be associated with one or more vessels to collect destroyed organics and reduce conductivity, resulting in lower total organic carbon (TOC) values. For example, GAC may be used to filter out contaminants, such as metals, chlorine, organics, etc. using a media bed that may be replaced periodically due to depletion. One or more sensors may be used to monitor and alert when to replace the media bed, for example due to pressure drop, flow rates, computed TOC values, and/or the like. While GAC is described in one example, nanofiltration may also be deployed. Furthermore, various other filtering and/or treatment processes may be used.

Embodiments of the present disclosure may continue to direct processed fluid to a high conductivity (HC) tank that may be used as a collection holding buffer tank. Further processing may continue at a Spent Process Water Reverse Osmosis (SPWRO) system, which may include one or more feedback loops in the event the processed wastewater does not maintain one or more desired set point conditions. For example, a flow path may return to the SPW or to the HC. In at least one embodiment, the SPWRO reduces conductivity in permeate and concentrates the reject, thereby reducing TOC as a byproduct. It should be appreciated that a series of RO devices may be used. Additionally, ROs may be used in combination with other methods such as Ion Exchange Medias, electrodeionization (EDI), electrodialysis reversal (EDR), or other membrane technologies may be used in place of RO to separate water from the stream containing ions and salts, resulting in a separation between permeate and reject. Flow may continue, for streams that are not rejected and returned to a previous step, to a deionized (DI) tank holding deionized water, to permeate flows, to a Deionized Reverse Osmosis (DIRO) as a recirculation/polishing loop, where one or more streams may also be returned to the HC and/or to the SPW. In at least one embodiment, DIRO is a polishing RO that reduces conductivity in permeate and concentrates the reject. Furthermore, the DIRO may reduce TOCs as a byproduct of the process. As discussed herein, additional methods or systems may also be used with and/or in place of the RO, including ion exchange medias, continuous electrodeionization (CEDI), electrodeionization (EDI), electrodialysis reversal (EDR), electrodialysis, or other membrane technologies. In at least one embodiment, systems and methods may include a loop feed system that feeds back to a production floor after undergoing one or more processes, such as additional UV disinfection or passing through one or more filters, such as bag filters. As a result, water may be disinfected and filtered.

Systems and methods of the present disclosure may also be directed toward a second train, which may be used to remove one or more components from a process stream, such as metals. In at least one embodiment, waste (e.g., spent chemical/metal concentration flows from a production floor) may be received at a vessel or tank associated with Metal Equalization (ME). The metals or chemical waste may include components such as Halogens, metals, organics, solvents, and/or the like. In at least one embodiment, components may have a threshold pH level, such as below 7. The waste may be directed through one or more filter stages, such as bag filters, to selectively remove metals or mixed alloys at a metal removal (MR) to harvest recyclable materials such as metals, alloys, powders, or sludge precipitates. The harvestable recyclable materials could be, for example, solid metals, solid alloys, metal salts, or metal oxides. In at least one embodiment, multiple different sets of MEs, filters, MRs, and/or combinations thereof may be used, for example, to designate different streams based on one or more properties. In at least one embodiment, metal removal may include methods and techniques such as ion exchange resins, electrolytic selective targeting, electroless metal plating, electrolytic nonselective targeting, and/or the like. Byproducts may also be processed, for example using one or more scrubbers. In at least one embodiment, recirculation may be used based on one or more analyzers or sensors that may monitor an output of the MR. It should be appreciated that various embodiments may use or combine a variety of different components for metal removal, including as non-limiting examples, a filter press, a sludge press, a screw press, a drum or vacuum drum filter, a centrifugal filter, a thermal distillation sludge thickener/dryer with or without vacuum, and flash distillation. Systems may also incorporate one or more support components, such as a neutral batch reactor, static mixer, or flow reactor with pH adjustment between 7-14, and/or coagulants, flocculants, polymers, clarifiers, and media additives.

In at least one embodiment, reduced metal may be processed by one or more neutral batch reactors that may include a mixer, baffles, and/or continuous recirculation pumps to facilitate a reaction process. Liquid or solid chemicals may be used for the reaction to adjust the pH up to approximately 14. As discussed herein, static mixers, gas injection or AOP such as ozone injection, or gas agitation may also be used. As a result, sulfuric acid dosing may be reduced or limited by reprocessing and using the waste. An output may be processed at a pH tank, which may be replaced with or used along with a filtration step, to collect process water from the production floor, RM dosing, and the neutral batch reactor. In at least one embodiment, pH is adjusted upstream of a drum filter that produces filter cake for disposal. The drum filter, in at least one embodiment, may be used for removal of solder mask and striped material (i.e. resists and others), as well as residual organic and other total suspended solids (TSS), total organic carbon (TOC), biochemical oxygen demand (BOD), Fat, Oil, Grease (FOG), and/or metal precipitants, metal salts, metal hydroxides or metal oxides. By removing these contaminates, downstream processes may be improved. The contaminants may be disposed in various embodiments. As discussed herein, various alternatives may be used along with or in place of the drum filter, including as non-limiting examples a filter press, a sludge press, a screw press, a drum or vacuum drum filter, a centrifugal filter, a thermal distillation sludge thickener/dryer with or without vacuum, and flash distillation. Systems may also incorporate one or more support components, such as a neutral batch reactor, static mixer, or flow reactor with pH adjustment between 7-14, and/or coagulants, flocculants, polymers, clarifiers, and media additives.

In at least one embodiment, output from the drum filter may flow to a filtered neutral tank and then to a Desalination Reverse Osmosis (DSRO) process. A flowline from the DSRO may be directed toward the SPW (e.g., to the first train). Additional flowlines may either loop back into the filtered neutral tank and/or be directed as an output to a brine tank. In at least one embodiment, the DSRO is used to reduce conductivity in permeate and concentrates the reject, which may reduce TOC as a byproduct. In at least one embodiment, multiple different ROs can be used and parameters may be tuned based on desired outputs. Moreover, as discussed herein, one or more valves, which may be controllable valves, may be used to divert various portions of the output flow, for example, based on meter readings and the like. Also, as discussed with respect to the first train, one or more additional or alternative processes, such as ion exchange medias, electrodeionization (EDI), electrodialysis reversal (EDR), and/or other membrane technologies may be used to facilitate separation between permeate and reject. In at least one embodiment, the brine tank serves as a buffer for feeding a dryer, which may be used to separate water from the brine to produce solid, inert material, non-hazardous waste and water boil-off distillate. The inter material may be non-reactive, or have a low reactivity. Non-hazardous waste may include any material that could be categorized as hazardous based on government or regulatory classifications or definitions of what constitutes hazardous material, but that is inert, non-reactive, minimally reactive, or safe for use. For example, if a material is classified as hazardous because it is generated during a particular process, like a F code classification in chrome plating processes, a particular output or separated material may still be considered as non-hazardous if it is inert or minimally reactive. In at least one embodiment, the dryer is operated under thermal heat and negative gauge pressure. As discussed herein, various alternatives may be used, which may also be used with the dryer, including RO, evaporation, and various other processes.

Systems and methods of the present disclosure address and overcome problems associated with existing treatment systems. In at least one embodiment, various embodiments provide an improved process flow that may include diversion valves for system balancing and protection. Furthermore, in at least one embodiment, metal selective or mixed metal targeting for recyclable ready metal alloys, powders, sludges, and the like may be incorporated. Systems and methods may also deploy dosing waste from RM to neutralize the pH tank instead of using additional chemical additives. Various embodiments may further incorporate a drum filter as a precursor for RO desalination to remove TSS, TOC, BOD, FOG, and metal hydroxide. Additionally, systems and methods may be used for production of dryer ready chemical waste brine or feed stock, from a chemical and metal concentrate waste stream. Various example embodiments discussed herein may include osmotically assisted reverse osmosis (OARO). OARO may include membrane technology that merges principles from forward osmosis and reverse osmosis to efficiently concentrate saline solutions. In OARO, a saline solution may be introduced on the permeate side of a membrane to reduce the net osmotic pressure difference, allowing water to permeate at lower hydraulic pressures while permitting a controlled exchange of salt. This mechanism enables the system to reach significantly higher brine concentrations compared to some traditional ultra-high-pressure reverse osmosis (RO) systems. OARO may achieve a brine concentration-reflected in its specific gravity—that is comparable to the specific gravity achievable from evaporation or distillation, but through a different approach. In a typical evaporation or distillation process, water is removed by applying heat to vaporize it, leaving behind a highly concentrated salt solution defined by its specific gravity. In contrast, OARO leverages a controlled osmotic gradient built through a staged system. Instead of using thermal energy, the OARO process introduces a moderately saline solution on the permeate side of the membrane. This step reduces the effective osmotic pressure difference across the membrane, allowing water to pass through at lower pressures and in a gradual, controlled manner. As water is selectively removed, the salt concentration in the remaining brine increases progressively, step by step, reaching levels akin to those produced by traditional evaporative methods. Essentially, while evaporation relies on a phase change to remove water, OARO mimics that concentration increase by orchestrating water removal via osmotic forces, ultimately resulting in a brine with the desired high specific gravity without the energy-intensive cost and potential thermal degradation issues that come with heating.

Other example embodiments may discussed herein may include immersion plating. Immersion plating may include a metal finishing process that deposits a thin layer of a more noble metal onto the surface of a less noble metal through a spontaneous chemical displacement reaction, rather than through the assistance of an external electric current. In example embodiments employing immersion plating, when an object is immersed in a plating solution containing ions of a more noble metal, these ions automatically replace atoms on the surface of the base metal, creating a uniform, adherent coating. Immersion plating offers some advantages because it bypasses the need for an external electric current. Instead of relying on an electrical energy source to drive the deposition of a more noble metal onto a base metal, immersion plating harnesses a spontaneous redox reaction. This reaction occurs naturally when a less noble metal is immersed in a solution containing ions of a more noble metal, leading to a controlled and uniform displacement process. Eliminating the need for electricity may simplify the plating setup, reduce energy consumption, and avoid complications that can arise from uneven current distribution or electrical equipment maintenance.

As discussed herein, various embodiments may deploy RO as a chemical brine concentrator. Such a configuration is different from existing techniques that primarily use RO to desalinate sea water or separate to clean city water. Furthermore, it should be appreciated that while RO may be described in one or more embodiments, systems and methods are not limited to the use of RO and other membrane technologies and/or electrodeionization (EDI), electrodialysis reversal (EDR), and ion exchange media may be used along with, or in place of, various RO processes. Similarly, embodiments may describe the use of intermediate tanks/vessels/containers as buffers, but one or more mass balance flows may be deployed for continuous operations without some or all of the tanks discussed herein. A non-limiting list of potential equipment that may be incorporated into embodiments of the present disclosure includes electrodeionization (EDI), electrodialysis reversal (EDR), Anion Cation Resin Media, Centrifugal Filtration, Filter press/Sludge Press, Decanting, CCRO-Closed Circuit R.O., Energy Recovery devices, High Pressure R.O, Ultra Filtration, Microfiltration, Nanofiltration, and Screw Press. Moreover, embodiments may include additional recovery of elements or materials from the waste through selective crystallization with or without a seed or catalyst additives. For example, if it is desired to remove copper from the waste, electroless plating techniques may be used to reduce copper ions in the waste to form crystalized copper particles. By selectively recovering desired materials or chemicals at a certain location in the process through the above described techniques, these materials or chemicals can be recovered and reused in other stages of the process to further reduce waste.

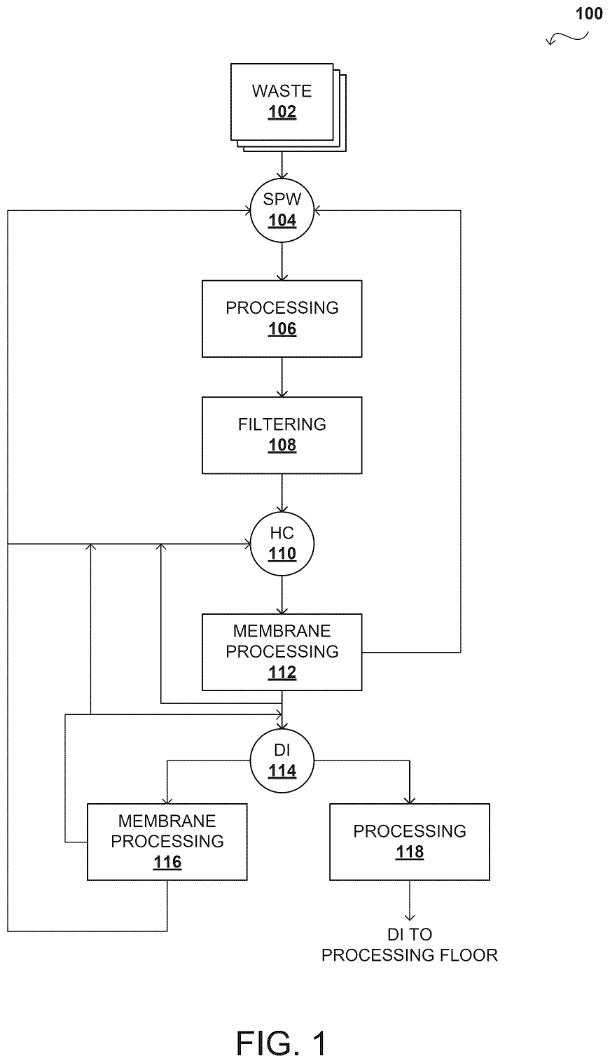

FIG. 1 illustrates an example flow diagram 100 that may be used with embodiments of the present disclosure. In at least one embodiment, the flow of FIG. 1 may be referred to as a “first train” or “green waste” process, but such designations are for illustrative purposes only and not intended to limit or otherwise restrict the scope of the present disclosure. The example begins with an input of waste 102 from one or more sources that may be generated from one or more manufacturing operations. By way of example, manufacturing operations may be associated with Printed Circuit Boards Fabrication (PCB FAB), General Metal Finishing (GMF), semiconductors manufacturing, chemical milling, Chemical Vapor Deposition (CVD) and Physical Vapor Deposition (PVD) manufacturing. In at least one embodiment, the waste includes rinse-water waste, concentrate waste, and film and mask developer waste. The waste may be directly generated during the process and/or may be provided as a feedback from one or more other processes in the system.

In at least one embodiment, the waste 102 corresponds to fluid waste (e.g., liquid, solid, gas, or combinations thereof). The waste may be water with suspended particles or chemical dispersed through the water, among various other options. The illustrated embodiment includes a spent process water (SPW) tank 104, which may be a vessel or other any suitable or reasonable type of storage container. Properties of the tank may be selected based on expected composition and operating conditions of the materials stored therein, including materials of fabrication, wall thicknesses, and/or the like. It should be appreciated that various embodiments may omit the SPW tank 104 and/or there may be multiple SPW tanks 104. For example, embodiments may include a modular system where different tanks may be added or removed responsive to expected processing loads. The modular system may be arranged on a platform or skid that can be added or removed, for example due to one or more fasteners associated with the modular system to direct fluid flow as desired. Furthermore, various embodiments may include multiple tanks that receive different types of inlet waste.

The SPW tank 104 may be referred to as an overall collection tank for spent rinse waters, permeate waters, distillate waters, and reject waters. For example, one or more processes, as discussed herein, may include the SPW tank 104 within a feedback loop that may use one or more valves to redirect fluid responsive to a determination that the fluid does not meet one or more threshold parameters. In at least one embodiment, the SPW tank 104 may store a variety of wastewaters that may also include various other components or portions, including but not limited to salts, metals, organic contaminants, and/or the like. Furthermore, other fluids that are associated with production may also be routed to the SPW tank 104 as waste, such as from dehumidifiers, temperature control condensation, rain water collection, and/or the like.

The SPW tank 104 may include or be associated with one or more process control components, such as various valves, sensors, orifices, fluid movers (e.g., pumps), and/or the like. The components may be used to facilitate flow through the system, redirect flow according to one or more control parameters, and/or the like. In this example, flow from the SPW tank 104 may be directed toward a processing segment 106, that may include one or more fluid processing operations, which may include, as non-limiting examples, ozone injection, advanced oxidation processing (AOP), ultra-violet (UV)/visible light processing, filtering, and/or the like. For example, in at least one embodiment, a train or series of processing operations may be performed on the outlet of the SPW tank 104. As one non-limiting example, an ozone/AOP, UV light, and filter process may be performed. Each process may include one or more processes. Additionally, the processes may be performed in a different order. In addition, flow from the SPW tank 104 may be recirculated back SPW tank 104 after undergoing fluid processing operations.

In at least one embodiment, the ozone process may include ozone injection or AOP to destruct and target organic and biofoul contaminants. As a result, the targeted organics may be broken down and filtered out. In at least one embodiment, ozone injection may include an inline system, such as a venturi injector that uses a differential pressure to inject ozone into the fluid to be treated. The ozone injection may break down organics and form particulates to be captured by filtration. In at least one embodiment, UV destruction may also be used to breakdown any residual ozone that was not consumed. Filtering may refer to one or more filtering processes, such as bag filters, that may be used to collect particulates. The filtering may include a series of filters with different sizes to filter out particulates in stages, which may reduce a likelihood of clogging at different stages of the filtering process. For example, a first stage may include a larger opening size in the filter, while a second stage includes a smaller size, which may gradually reduce along a number of stages to a target size. In at least one embodiment, one or more sensors may be associated with the processing zone 106 to monitor for oxygen or other parameters. For example, one or more pressure sensors may be used to determine whether a pressure drop exceeds a threshold, which may indicate clogged filters to be replaced. As a result, performance may be evaluated and different parameters may be adjusted and/or maintenance operations may be scheduled. For example, over time, predictive monitoring may be used to anticipate a maintenance schedule for different portions of the process, such as the filter, based on input flow rates, upstream processes, and/or the like. Predictive monitoring may include, for example, advanced control and data analysis methods that predictively control the system based on monitored input waste and operation time rather than relying on feedback control in response to measured performance parameters. This predictive, feed forward control, may monitor incoming waste, operation time of the system, and other input parameters and determine control adjustments based on data measurements and analysis conducted in a computing device. The feed forward control may be used to adjust components in the system to run at the proper operating conditions and to adjust processing setpoints. The feed forward control can be implemented in a computing device using, for example, multivariate data analysis and control methods such as principal component analysis (PCA), partial least squares regression (PLS), Fourier transform analysis, and/or advanced machine learning and artificial intelligence modeling and control techniques. Moreover, the system may use a combination of feedback and feedforward data analysis and control methods to monitor operation and make adjustments.

The output from the processing zone 106 flows to a filtering zone 108 in the illustrated embodiment. The filtering zone 108 may include one or more processes that include, without limitation, granular activated carbon (GAC), nanofiltration, and/or the like. The GAC process may be used to collect destroyed organics and reduce conductivity, resulting in lower TOC values. For example, the GAC process may filter out contaminants such as metals, chlorine, organics, and the like. An output may flow to a high conductivity (HC) tank 110. As noted herein, the tank 110 may share one or more features with the tank 104 with respect to using a series of tanks, using modular tanks, and having processing control components such as valves, gauges, sensors, fluid movers, and/or the like. In at least one embodiment, the HC tank 110 may be considered a buffer tank and, in certain embodiments, may be eliminated in favor of process controls to provide a circulating system without intermediate buffer storage.

In this example, a membrane processing zone 112 may receive flow from the HC tank 110, which is then routed to a deionized (DI) water tank 114. The membrane processing zone 112 may include one or more reverse osmosis (RO) units, which may be referred to as SPWRO. The SPWRO may reduce conductivity in permeate and concentrates the reject, reducing the TOC. In at least one embodiment, the membrane processing zone 112 may include ROs in multiple different configurations, for example in a series, and may further operate at different parameters based on desired output flows. As shown in this example, various diversion valves may be installed to permit backflow for reprocessing if one or more sensors determines that output criterion are not satisfied. While RO may be described in this embodiment, alternative methods such as ion exchange medias, electrodeionization (EDI), electrodialysis reversal (EDR), and other membrane technologies may be used with embodiments of the present disclosure.

There may be one or more output flows from the illustrated DI tank 114. Example, one may be directed toward a second membrane processing zone 116, which may include one or more additional RO units, such as a polishing RO, to further reduce conductivity in permeate and concentrates the reject. Further alternatives, as noted herein, may be used, along with various diversion valves for feedback. Various trips through the process may be performed until one or more criterion are satisfied, and then another processing zone 118 may be used to further filter, utilize UV methods, and/or the like to produce DI water that may be used in a variety of processes.

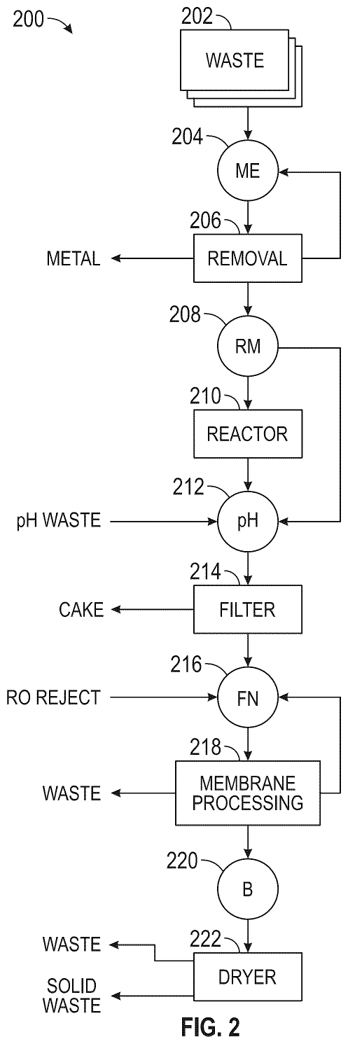

FIG. 2 illustrates an example flow diagram 200 that may be used with embodiments of the present disclosure. In at least one embodiment, the flow of FIG. 2 may be referred to as a “second train” or “blue waste” process, but such designations are for illustrative purposes only and not intended to limit or otherwise restrict the scope of the present disclosure. The example begins with an input of waste 202 from one or more sources that may be generated from one or more manufacturing operations. By way of example, as discussed herein, manufacturing operations may be associated with PCB FAB, GMF, semiconductors manufacturing, chemical milling, and PVD manufacturing, among various other options. In at least one embodiment, the waste includes rinse-water waste, concentrate waste, and film and mask developer waste and the waste may be directly generated during the process and/or may be provided as a feedback from one or more other processes in the system.

The illustrated waste 202 in FIG. 2 is provided to a metal equalization (ME) tank 204, which may be used to collect spent chemical/metal concentrated flows from a production flow. As discussed herein, tank may refer to one or more storage containers, which may be particularly selected based on composition of materials stored therein, operating conditions, and/or the like. Furthermore, the tanks may be provided in a modular arrangement to permit additional storage capacity and/or reduce capacity. The modular arrangement may include vessels or containers on skids or platforms with associated flow control equipment that may permit rapid installation and removal. In at least one embodiment, chemical waste may include flows that include components such as halogens, metals, organics, solvents, and/or the like. In at least one embodiment, flows may be divided into a variety of different tanks 204, for example by selectively directing flows based on concentrations, pH, and/or the like. Systems and methods may include one or more sensors or analyzers for routing the flow to an appropriate tank 204.

In this example, a removal process 206 may include an upstream filtration process, such as flowing through one or more filters, such as bag filters, and then executing one or more removal operations including, but not limited to ion exchange, electrolytic selective targeting, electrolytic nonselective targeting, and/or others. In at least one embodiment, during metal reduction (plating), water is consumed by electrolysis which produces H+ and oxygen gas. Organic molecules may be oxidized by the anode as well to produce organic radicals, CO₂ and H₂O. Embodiments may also include associated processing steps, which may include particulate recovery, off gas scrubbing, and/or the like. Additionally, in this example, a recirculation loop may be incorporated to inhibit oversaturation. One or more analyzers, by way of example, may be incorporated into the loop to determine whether to activate one or more valves to redirect flow along the loop.

As discussed herein, the removal process 206 may be used to harvest recoverable and/or recyclable metal alloys, powders, or sludge precipitates. Along with the methods discussed herein, additional or alternative processes for metal recovery may include a filter press, a sludge press, a screw press, a drum or vacuum drum filter, a centrifugal filter, a thermal distillation sludge thickener/dryer with or without vacuum, and flash distillation. Systems may also incorporate one or more support components, such as a neutral batch reactor, static mixer, or a flow reactor with pH adjustment between 7-14, and/or coagulants, flocculants, polymers, clarifiers, and media additives. An output of the removal process 206 may include one or more metals. The one or more metals or metal alloys may be recycled and reused, stored, sold, and/or the like.

Reduced metals may be provided to one or more reduced metals tanks 208 that may be used as a feed to one or more reactors 210, such as a neutral batch reactor. The reactor may include mixers, baffles, and/or continuous circulation pumps to facilitate the reaction process. Furthermore, liquids or solid chemicals may be incorporated to increase the pH of the metals. In at least one embodiment, static mixers or gas agitators, among other elements, may also or alternatively be used.

The reactor output may be provided to a pH tank 212 along with collected process water and RM dosing. Accordingly, systems and methods may be used to engineer out sulfuric acid dosing using the pH waste, which may be collected from other processes. The system may also dose one or more other acids. It should be appreciated that the pH tank 212 is provided by way of example and may be omitted in favor of one or more filtration steps, as discussed herein. In embodiments that include the pH tank 212, an input may include high pH material from stripper or mask lines that may be neutralized by the RM dosing. As a result, a pH adjusted output feed may be generated for a downstream filtering process. For example, acidic waste from RM may adjust the waste to a neutral pH of approximately 7. Furthermore, alternative use of various chemicals to balance pH may be used. For example, one or more properties of the output flow may be monitored and, responsive to a reading, different dosing of the pH waste and/or additional chemicals may be applied responsive to the reading.

The illustrated filter 214 may be a drum filter, as one non-limiting example, that produces sludge filter cake for disposal. The filter 214 may enable removal of solder masks and striped materials (e.g., resist and others), as well as residual organic and other TSS, TOC, BOD, metal hydroxides, and/or the like. In certain embodiments, the filter 214 may include one or more filters, which may be arranged in different configurations (e.g., parallel, series, etc.) and may operate at different parameters to execute various filtering steps or stages. Use of the filter 214 may remove certain contaminates that may negatively affect one or more downstream process. Instead, filtering material may harvest the contaminates for safe disposal. As discussed herein, various alternatives may be used, such as various filtration and membrane technologies, including, but not limited to, a filter press, a sludge press, a screw press, a drum or vacuum drum filter, a centrifugal filter, a thermal distillation sludge thickener/dryer with or without vacuum, and flash distillation. Systems may also incorporate one or more support components, such as a neutral batch reactor, static mixer, or flow reactor with pH adjustment between 7-14, and/or coagulants, flocculants, polymers, clarifiers, and media additives.

The output of the filter 214 is provided to a filtered neutral tank 216 for use by a membrane processing unit 218, which in one example includes a desalination reverse osmosis (DSRO) unit. The DSRO may be used to reduce conductivity in permeate and concentrates reject, reducing TOC. In at least one example, multiple RO units may be placed in series or parallel and may operate at one or more different operating conditions. As discussed herein, alternatives or additional methods may also be incorporated, including ion exchange medias, electrofiltration processes, electro chemical oxidation processes, continuous electrodeionization (CEDI), electrodeionization (EDI), electrodialysis reversal (EDR), electrodialysis, and other membrane technologies that may be used for separation between permeate and reject.

Various embodiments may further include diversion values to facilitate flow back loops, such as directing waste to one or more alternative processes, such as the first train, and/or back to the tank 216. Output flows to a brine tank 220 that may then be directed toward a drying unit 222. The brine tank 220 may be a buffer for feeding the drying unit 222, but as noted herein, various processing configurations may be adjusted to remove the use of buffer storage. In at least one embodiment, the DSRO may be executed as a batch process that does not use the tank 220. In at least one embodiment, the drying unit 222 may also be referred to as a dryer and may include a thermal distillation unit (e.g., dryer and evaporator). The distillate may be redirected to another process (e.g., the first train) and the remaining solid waste may be disposed. For example, the water separated from the brine may be reprocessed and the solid non-hazardous or inert waste and water boil-off will be further processed and disposed of. While dryers are described, it should be appreciated that alternative embodiments may include features such as other RO units, evaporation, and the like.

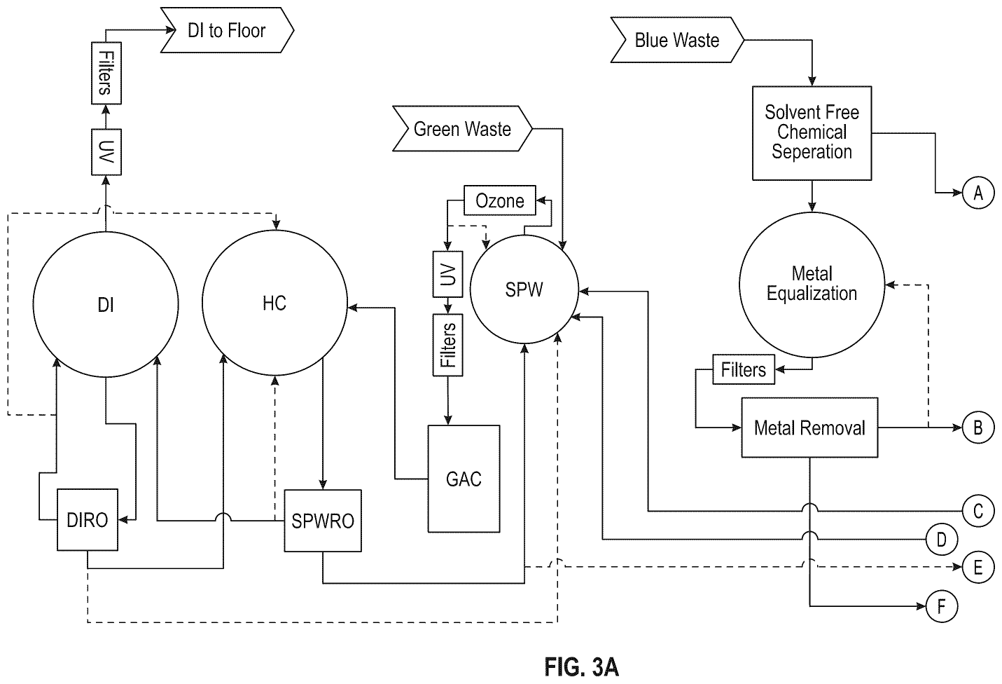

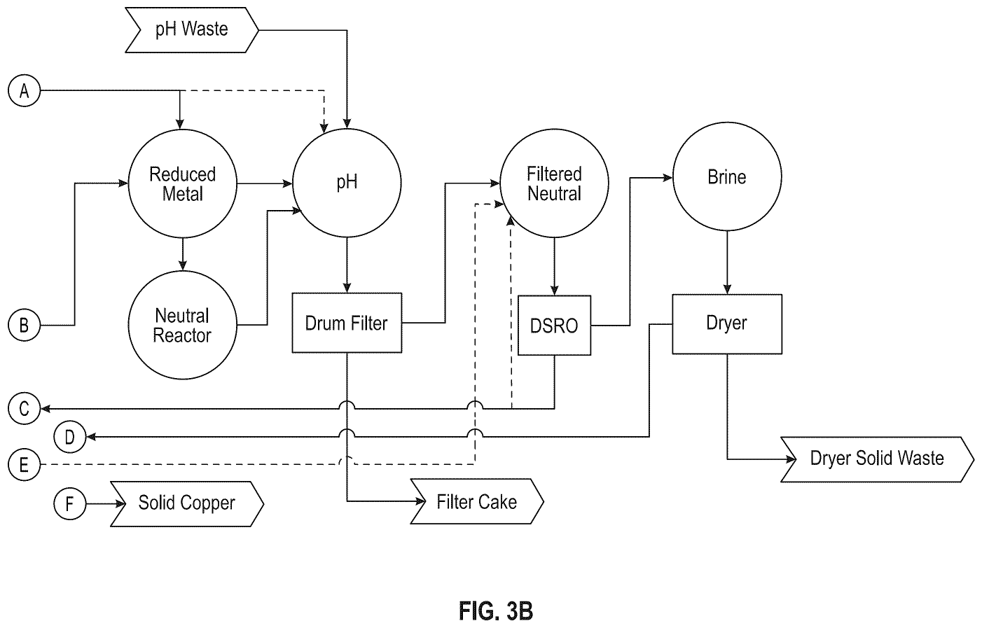

FIGS. 3A and 3B include an example process flow 300 that may be used with embodiments of the present disclosure. In this example, the first and second trains of FIGS. 1 and 2 are illustrated within a combined process. Moreover, various features discussed herein have been illustrated with specific features, such as the processing downstream of the SPW including the ozone process, the UV process, and the filter stages, as one example. As another example, FIGS. 3A and 3B include a representation of injecting dosing from the reduced metal stream as a neutralizer into a pH tank containing the neutral waste stream to modify the pH of the neutral metal stream. However, as discussed herein, the configuration shown is by way of non-limiting example and various alternatives or additional processes may be added within the scope of the present disclosure. The example process flow 300 continues from FIG. 3A to FIG. 3B as illustrated by the signposts A, B, C, D, E, and F.

Moreover, one or more of the waste streams may be pre-treated with a media-based pre-treatment system, such as the blue waste stream being pre-treated with a solvent free chemical separation system before entering the a vessel or tank associated with Metal Equalization (ME) as illustrated in FIGS. 3A and 3B. The media-based pre-treatment system may be dependent upon the waste stream being treated, and such media based pre-treatment systems may only be used with waste streams that have a particular chemical properties or properties of interest. By using a pre-treatment system, specific components may be removed from the waste stream before it enters further processing. For example, if a waste stream may contain components that could be hazardous to equipment used later in the processing, those components could be removed in the pre-treatment system. Additionally, the pre-treatment system may allow for regeneration of chemical baths used in the wastewater treatment or one or more manufacturing processes without the need for a complete remake of the chemical baths. By using the media-based treatments, instead of chemical solvents which may be hazardous and harmful to the environment, the treatment system offers improved safety and environmental control. Moreover, the treatment system can be implemented using modules that can be inserted into various locations in the manufacturing and treatment processes. This modularity and mobility allow for the treatment of many different chemicals and bath volumes at one or more locations.

The media-based treatment system may be used to treat a wide range of chemical types may be treated by this approach, including charged atoms/molecules (e.g. cations/anions), polar molecules (e.g. soluble organics or complexes), and non-polar molecules (e.g. insoluble organics, inorganic precipitates). The goal of the treatment may vary depending on the chemical being treated and the location of the treatment in the overall process. For example, in the case of treating cupric chloride etchant, direct plating is not ideal given the potential for chlorine gas release into the facility or environment. Thus, pretreatment of the etchant with a media-based system enables the transfer of copper-ions to a safe plating media enabling recovery. The media may be, for example, a resin which draws and captures metal ions from the etchant in an absorption process. In another case, the media-based treatment system may target halogen ions that can cause degradation of plating cells. As such, a media system may be used to remove halogens before the plating treatment. Further, this same halogen bath may be treated with a different media to target the removal of copper, with the media again being a resin for example that draws and captures metal ions; thus, enabling the bath to be regenerated without the need for a complete remake. By capturing the excess metal ions, the chemistry of the bath can be regenerated without needing to be fully replaced. These are just some examples of the ways in which a media system may be used to optimize bath life and wastewater treatment capacity/equipment.

The media-based pre-treatment system may be implemented such that the fluid being treated is brought into direct contact with the media. The system may include one or more of a media bed, a continuous stirred tank reactor (CSTR) holding the media, a batch reactor (BR), a fluidized bed reactor (FBR), a packed bed reactor (PBR), a counter current or co-current flow reactor, one or more specialized filter housings containing the media, and one or more absorption/striping style columns packed with the media. The design and operation of the media-based treatment system, including the components used to hold the media and bring it into contact with the fluid being treated, may depend on the chemical being treated and the location within the manufacturing and treatment system. Other components and modules and components to hold the media may also be used. The media may be used and reused via in-house regeneration, or the media may be used only once before being shipped from the facility as solid waste.

Pre-treatment of certain etchants and other chemicals may also be accomplished using RO or other membrane technologies, electrochemical oxidation/reduction, electrofiltration, miscible or immiscible liquid-liquid extraction (LLE), element/compound/molecule selective crystallization with or without seed/catalyst additives.

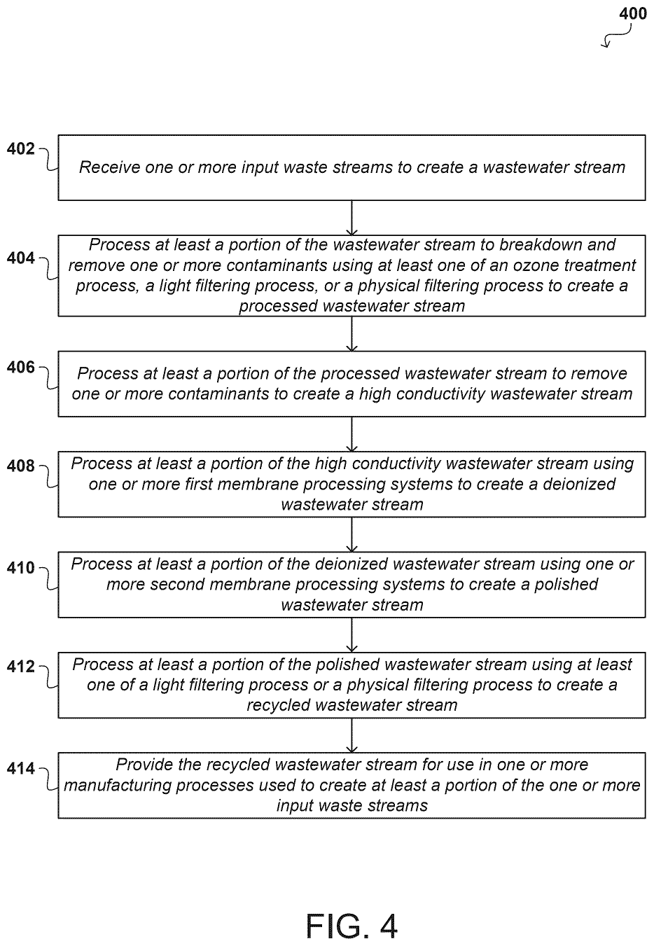

FIG. 4 illustrates an example flow chart for an example process 400 to process a wastewater stream, that may be used with embodiments of the present disclosure. It should be understood that for this and other processes presented herein that there can be additional, fewer, or alternative operations performed in similar or alternative order, or at least partially in parallel, within the scope of various embodiments unless otherwise specifically stated. In this example, one or more input waste streams are received to create a wastewater stream 402. The input waste streams may be provided by one or more portions of a manufacturing process, as discussed herein, and may include water with chemicals, contaminants, and/or the like distributed throughout the streams. In at least one embodiment, the one or more input waste streams are stored within one or more tanks or containers. In at least one embodiment, tanks or containers are omitted.

The example further includes processing at least a portion of the wastewater stream 404. Processing may include one or more operations that breakdown and remove one or more contaminants, which may include organic or biofoul contaminants, as non-limiting examples. In at least one embodiment, processing may include using at least one of an ozone treatment process, a light filtering process or a physical filtering process, as discussed herein. An output of the processing may be preferred to as a processed wastewater stream, which may be further processed to remove one or more contaminants to create a high conductivity wastewater stream 406. For example, a GAC system may be used to collect destroyed organics and reduce conductivity. The high conductivity wastewater stream may then be processed by one or more first membrane processing systems to create a deionized wastewater stream 408. For example, one or more RO units may be used to process at least a portion of the high conductivity wastewater stream.

In at least one embodiment, at least a portion of the deionized wastewater stream may be processed by one or more second membrane processing systems, such as additional ROs, to create a polished wastewater stream 410. The polished wastewater stream may be part of an output loop that uses one or more light filtering processes and/or one or more physical filtering processes to create a recycled wastewater stream 412. In at least one embodiment, the recycled wastewater stream may then be reused as part of a manufacturing process that was used to generate at least one of the initial one or more input waste streams 414. In this manner, wastewater from a manufacturing process may be recycled and reused.

Although some embodiments discussed herein (such as, e.g., FIG. 4) describe a “recycled wastewater stream,” it is understood that “recycled wastewater stream” may also be a to a “recycled water stream of usable water.” As a nonlimiting example, once the wastewater has been treated with ozone, light filtering, and physical filtering processing, “ ” it may become a usable water stream that can be recovered and used for multiple purposes within the wastewater treatment system, or it may be sent externally to the wastewater treatment system.

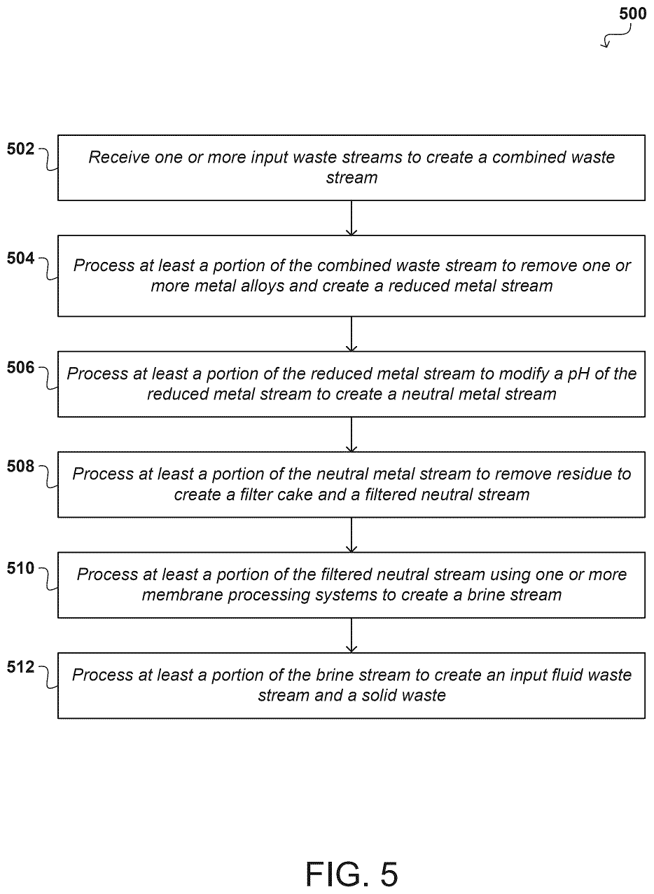

FIG. 5 illustrates an example flow chart for an example process 500 to process a waste stream, that may be used with embodiments of the present disclosure. In this example, one or more input waste streams are received to create a combined stream 502. The input waste streams may be provided by one or more portions of a manufacturing process, as discussed herein, and may include water with chemicals, metals, contaminants, and/or the like distributed throughout the streams. In at least one embodiment, the one or more input waste streams are stored within one or more tanks or containers. In at least one embodiment, tanks or containers are omitted.

The example further includes processing at least a portion of the combined waste stream 504. Processing may include one or more operations that filter and/or remove metal alloys and the like from the combined waste stream. As one example, a metal removal process may be initiated to extract one or more metals, which may be targeted based on the process selected. The removed metal may be reused or recycled and the remaining portions of the stream may generate a reduced metal stream. In at least one embodiment, the reduced metal stream may be processed to modify the pH of the reduced metal stream to create a neutral metal stream 506. The neutral metal stream may be further processed to remove residue and create a filter cake and a filtered neutral stream 508. The filter cake may be disposed of. In at least one embodiment, the filtered neutral stream may be further processed, using one or more membrane processing systems, to create a brine stream 510. The brine stream may then be dried to generate an input fluid waste stream and a solid waste 512. In at least one embodiment, the solid waste may be disposed of while the input fluid waste stream may be processed by one or more additional wastewater treatment systems. Moreover, brine stream may be separated into an input fluid waste stream and other components or materials. These other components and materials may be solid, and/or they may be inert or non-hazardous materials regardless of whether they are solid. In addition, the brine stream may have an input waste stream taken out of it, leaving a concentrated brine stream. This concentrated brine stream can then be sent for storage in, for example, a deep well injection or an evaporation pond.

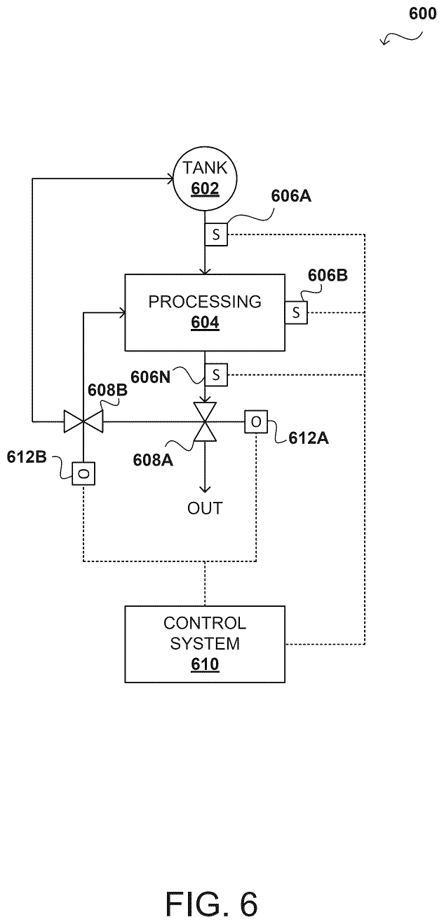

FIG. 6 illustrates a schematic diagram of a control scheme 600 that may be used with embodiments of the present disclosure. In this example, a tank or container 602 is illustrated that may store or otherwise maintain one or more streams for processing, as discussed herein. In at least one embodiment, the tank or container 602 is a modular system that maybe added or remove and may include support components such as valves, sensors, other instrumentation, and/or the like. In this example, a portion of a process flow is illustrated where an output from the tank 602 is provided to a processing unit 604, which may include a variety of units discussed herein, such as filtering units, ozone injection, membrane processing, reactors, removal units, dryers, and/or the like. This example further includes sensors 606A-606N illustrated at various portions in the system, such as at tank outlets (606A), as part of processing units (606B), or at processing unit outlets (606N). It should be appreciated that there may be more or fewer sensors 606 and that the illustrated sensor positions are provided by way of non-limiting example only.

Embodiments of the present disclose may use the sensors 606, one or more valves 608, and a control system 610 to regulate flow through the system, such as by providing feedback loops to reprocess portions of the flow based on one or more properties. In this example, the sensors 606 may include pressure sensors, flow sensors, temperature sensors, material analyzers, and/or other measurement devices that may be used to extract information with respect to a portion of the process, convert that information into a measurement representative of data associated with the process, and then provide that information to a control system 610 that may send a signal to one or more valves 608A and 608B (e.g., to one or more operators 612 associated with the one or more valves), to redirect or manage flow responsive to the sensor measurements. In this example, an outlet flow from the processing unit 604 may be evaluated by one or more sensors 606B, 606N that may transmit one or more operating parameters to the control system 610. The control system 610 may include one or more processing units and one or more memories that may include software instructions that, when executed, may generate one or more commands responsive to information provided by the one or more sensors 606B, 606N. For example, the commands may be relayed to operators 612A and 612B to adjust a direction of flow. In one non-limiting example, information from the sensor 606N may cause the control system 610 to transmit a signal to the operator 612A to redirect flow associated with the valve 608A back to the processing unit 604. In this manner, operational parameters may be monitored and automatically adjusted.

The foregoing disclosure and description of the disclosed embodiments is illustrative and explanatory of the embodiments of the invention. Various changes in the details of the illustrated embodiments can be made within the scope of the appended claims without departing from the true spirit of the disclosure. The embodiments of the present disclosure should only be limited by the following claims and their legal equivalents.

1. A wastewater treatment method, comprising:
receiving one or more input waste streams to create a wastewater stream;
processing at least a portion of the wastewater stream to breakdown and remove one or more contaminants using at least one of an ozone treatment process, a light filtering process, or a physical filtering process to create a processed wastewater stream;
processing at least a portion of the processed wastewater stream to remove one or more contaminants to create a high conductivity wastewater stream;
processing at least a portion of the high conductivity wastewater stream using one or more first membrane processing systems to create a deionized wastewater stream;
processing at least a portion of the deionized wastewater stream using one or more second membrane processing systems to create a polished wastewater stream;
processing at least a portion of the polished wastewater stream using at least one of a light filtering process or a physical filtering process to create a recycled wastewater stream; and
providing the recycled wastewater stream for use in one or more manufacturing processes used to create at least a portion of the one or more input waste streams.

2. The wastewater treatment method of claim 1, wherein the light filtering process includes an ultra-violet light or visible light filtering process.

3. The wastewater treatment method of claim 1, wherein a granular activated carbon process is used to create the high conductivity wastewater stream.

4. The wastewater treatment method of claim 1, wherein the one or more first membrane processing systems includes at least one of reverse osmosis, ion exchange media process, electro deionization, or electrodialysis reversal.

5. The wastewater treatment method of claim 1, further comprising:
reprocessing at least one of the high conductivity wastewater stream, the deionized wastewater stream, or the polished wastewater stream.

6. A wastewater treatment method, comprising:
receiving one or more input waste streams to create a combined waste stream;
processing at least a portion of the combined waste stream to remove one or more metal alloys and create a reduced metal stream;
processing at least a portion of the reduced metal stream to modify a pH of the reduced metal stream to create a neutral metal stream;
processing at least a portion of the neutral metal stream to remove residue to create a filter cake and a filtered neutral stream;
processing at least a portion of the filtered neutral stream using one or more membrane processing systems to create a brine stream; and
processing at least a portion of the brine stream to create an input fluid waste stream and a solid waste.

7. The wastewater treatment method of claim 6, wherein removing the one or more metal alloys includes using at least one of an ion exchange resin, electrolytic selective targeting;
or electrolytic nonselective targeting.

8. The wastewater treatment method of claim 6, further comprising:
injecting dosing from the reduced metal stream as a neutralizer into a pH tank containing the neutral waste stream to modify the pH of the neutral metal stream.

9. The wastewater treatment method of claim 6, wherein the one or more membrane processing systems includes at least one of reverse osmosis, ion exchange media process, electro deionization, or electrodialysis reversal.

10. The wastewater treatment method of claim 6, wherein the input fluid waste stream and the solid waste are created using one or more drying processes.

11. A waste treatment method, comprising:
receiving one or more input waste streams to create a wastewater stream;
processing at least a portion of the wastewater stream to breakdown and remove one or more contaminants using at least one of an ozone treatment process, a light filtering process, or a physical filtering process to create a processed wastewater stream;
processing at least a portion of the processed wastewater stream to remove one or more contaminants to create a high conductivity wastewater stream;
processing at least a portion of the high conductivity wastewater stream using one or more first membrane processing systems to create a deionized wastewater stream;
processing at least a portion of the deionized wastewater stream using one or more second membrane processing systems to create a polished wastewater stream;
processing at least a portion of the polished wastewater stream using at least one of a light filtering process or a physical filtering process to create a recycled wastewater stream;
providing the recycled wastewater stream for use in one or more manufacturing processes used to create at least a portion of the one or more input waste streams;
receiving one or more input metal waste streams to create a combined waste stream;
processing at least a portion of the combined waste stream to remove one or more metal alloys and create a reduced metal stream;
injecting dosing from the reduced metal stream as a neutralizer into a pH tank containing the neutral waste stream to modify the pH of the neutral metal stream;
processing at least a portion of the neutral metal stream to remove residue to create a filter cake and a filtered neutral stream;
processing at least a portion of the filtered neutral stream using one or more membrane processing systems to create a brine stream; and
processing at least a portion of the brine stream to create an input fluid waste stream and a solid waste.
